(19) United States
(12) Patent Application Publication
(10) Pub. No.: US 2026/0132819 A1
(43) Pub. Date: May 14, 2026

(54) SEAL ASSEMBLIES FOR IN-WHEEL OUTER ROTOR ELECTRIC MOTORS

(71) Applicant: Donut Lab Development Oü, Harju maakond (EE)

(72) Inventors: Gareth Roberts, Swindon (GB); Joshua Best, Wiltshire (GB); Ville Piippo, Haarajoki (FI); Georg Seema, Harju (EE)

(21) Appl. No.: 18/944,826

(22) Filed: Nov. 12, 2024

(51) Int. Cl. F16C 33/80; H02K 7/08

(52) U.S. Cl. CPC F16C 33/80; H02K 7/088; F16C 2380/26

(57) ABSTRACT

Seal assemblies for in-wheel outer rotor electric motors are disclosed. An example in-wheel electric motor includes a stator, a rotor, a bearing, and a lip seal. The stator includes a seal plate. The rotor circumscribes the stator. The rotor is configured to rotate relative to the stator. The bearing is located between the rotor and the stator. The lip seal is located radially outward from the bearing. The lip seal includes a base and a flexible lip. The base is coupled to the rotor. The flexible lip extends from and is movable relative to the base, the flexible lip is configured to engage the seal plate when the rotor is not rotating relative to the stator. The flexible lip is further configured to be spaced apart from the seal plate when the rotor is rotating relative to the stator.

### FIELD OF THE DISCLOSURE

This disclosure relates generally to electric machines and, more specifically, to seal assemblies for in-wheel outer rotor electric motors.

### BACKGROUND

Electric motors typically include a stator and a rotor, with the rotor being configured to rotate relative to the stator. The stator and the rotor can be implemented in either an inner rotor configuration in which the stator circumscribes the rotor, or conversely in an outer rotor configuration in which the rotor circumscribes the stator. Electric motors are widely used across multiple industries (e.g., automotive, medical, household, etc.) and a variety of applications including vehicles, appliances, tools, fans, blowers, turbines, compressors, pumps, etc.

Electric vehicles have risen in popularity over the past decade. Electric vehicles are typically powered by one or more electric motor(s) that draw(s) electricity from an onboard rechargeable battery. Electric vehicles exist in many forms; wheeled electric vehicles, for example, include cars, vans, trucks, motorcycles, scooters, etc. that include at least one wheel powered by an electric motor. The majority of wheeled electric vehicles include powertrains having an inboard electric motor, transmission, and driveline, all of which contribute to the mass, complexity, and losses of the propulsion system, as well as a volume penalty within the chassis of the vehicle. In some implementations of a wheeled electric vehicle, the primary components of the electric motor are integrated into and/or incorporated within the wheel itself. Such implementations are commonly referred to as “in-wheel” electric motors. A key advantage of in-wheel electric motors is the ability to eliminate many if not all of the aforementioned peripheral components and the penalties associated therewith, and also to provide significant improvement in transient performance.

In-wheel electric motors typically include bearings located between the rotor and the stator of the electric motor, with the bearings being configured to support and/or guide the rotation of the rotor relative to the stator. There is typically a need for each bearing of the electric motor to be sealed by a bearing seal. Ideally, bearing seals are configured to: retain grease or oil in the bearings; prevent contaminants and/or pollutants from entering the bearings and/or, more generally, from entering the electric motor; reduce seal friction to improve vehicle efficiency; work across a broad range of temperatures; demonstrate long life; and provide ease of installation. The internals of in-wheel electric motors and the large bearings required by such motors tend to be susceptible to contamination. Large bearings operate at a larger diameter and, therefore, at higher surface speeds. These higher operational speeds lead to bearing and sealing problems such as increased temperatures, increased friction, increased wear of solid components, and reduced life of oils and greases in the bearings. Conventional seal arrangements are accordingly ineffective when an in-wheel electric motor operates at high speeds.

### BRIEF DESCRIPTION OF THE DRAWINGS

FIG. 1 is a side view of an example electric motor having an outer rotor configuration.

FIG. 2 is a block diagram of an example electric vehicle including an in-wheel electric motor.

FIG. 3 is a perspective view of an example implementation of the electric vehicle of FIG. 2.

FIG. 4 is a perspective sectional view of an example electric motor including a first example seal assembly.

FIG. 5 is an enlarged view of a portion of FIG. 4.

FIG. 6 is a cross-sectional view of a portion of the electric motor of FIG. 4.

FIG. 7 is an enlarged view of a portion of FIG. 6 modified to illustrate an example seal running surface.

FIG. 8 is a perspective sectional view of the electric motor of FIGS. 4-6 illustrating an example first operating state of the electric motor.

FIG. 9 is a perspective sectional view of the electric motor of FIGS. 4-6 illustrating an example second operating state of the electric motor.

FIG. 10 is a perspective sectional view of an example electric motor including a second example seal assembly.

FIG. 11 is a perspective sectional view of an example electric motor including a third example seal assembly.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Electric machines are widely used across multiple industries (e.g., automotive, medical, household, etc.) and a variety of applications including vehicles, appliances, tools, fans, blowers, turbines, compressors, pumps, etc. Example electric motors disclosed herein are configured as in-wheel electric motors for electric vehicles. An in-wheel electric motor is one form of a direct drive electric machine. The disclosed electric motors can alternatively be used in other industries and/or other direct drive electric machine applications that may or may not pertain to electric vehicles, and that may or may not include one or more wheel(s).

As discussed above, in-wheel electric motors typically include bearings located between the rotor and the stator of the electric motor, with the bearings being configured to support and/or guide the rotation of the rotor relative to the stator. For in-wheel electric motors having an outer rotor configuration in which the rotor circumscribes the stator, the bearings have a relatively large diameter (e.g., compared to the diameter of a bearing included in an electric motor having an inner rotor configuration) that requires the implementation of correspondingly large bearing seals. The relatively large diameter of the bearings and the bearing seals causes the surface speed of the bearing seals to be relatively high. The relatively high surface speed of the bearing seals can be problematic with regard to the production of increased temperatures, increased friction, increased wear of solid components, and reduced life of oils and greases in the bearings.

The relatively large diameter of the bearings and the bearing seals associated with in-wheel outer rotor electric motors also causes the electric motor to be susceptible to the entry of contaminants and/or pollutants into the electric motor. This drawback is of particular importance in a high voltage system such as the inside of an in-wheel electric motor, where the presence of contaminants and/or pollutants such as water or rust can negatively impact the insulation performance of the electric motor. The entry of contaminants and/or pollutants into an in-wheel electric motor can also negatively impact the creepage and clearance characteristics of the electric motor (e.g., the distances allowed between conductors across gaps and along surfaces in a high voltage electric motor). Creepage and clearance characteristics for electric motors are governed by standards that depend on the “Pollution Degree Number” classification system. Per such standards, electric motors having higher levels of pollution degree are not allowed to be as compact, which therefore negatively impacts the packaging size of the electric motor.

Example in-wheel electric motors disclosed herein have an outer rotor configuration. The disclosed in-wheel electric motors include seal assemblies (e.g., seal arrangements) that advantageously incorporate lip seals having flexible lips, with the lip seals being located radially outward from the bearings and/or the bearing seals of the electric motor. When the rotor of the electric motor is moving at a rotational speed that is less than a threshold rotational speed (e.g., when the rotor is not moving), the flexible lip of each lip seal engages (e.g., contacts) a corresponding seal plate of the stator, thereby preventing contaminants and/or pollutants from reaching the corresponding bearing seal and/or the corresponding bearing of the electric motor. When the rotor of the electric motor is moving at a rotational speed that is greater than or equal to the threshold rotational speed, the movement of the rotor generates a centrifugal rotational force exceeding the force of gravity. The generated centrifugal rotational force is transferred to the flexible lip of each lip seal and is applied thereto. The applied centrifugal rotational force causes the flexible lip of each lip seal to become spaced apart from (e.g., out of contact with) the corresponding seal plate of the stator, thereby enabling any contaminants and/or pollutants that may be located within the electric motor (e.g., between the bearing seals and the lip seals) to be propelled out of (e.g., radially outward from) the electric motor via the applied centrifugal rotational force.

By taking advantage of the relatively high centrifugal rotation forces generated by the rotor movement of an in-wheel electric motor having an outer rotor configuration, the seal assemblies disclosed herein implement a layered and/or tiered seal arrangement that advantageously protects the bearings and/or the bearing seals of the electric motor from exposure to contaminants and/or pollutants while also reducing (e.g., minimizing) friction losses which typically occur at the interfaces formed between respective ones of the seals and corresponding respective ones of the seal plates. The reduction of such friction losses advantageously improves the overall efficiency of the in-wheel electric motor, and also improves the life expectancy of the seals included within the seal assembly of the in-wheel electric motor.

In some disclosed examples, an in-wheel electric motor includes a stator, a rotor, a bearing, and a lip seal. The stator includes a seal plate. The rotor circumscribes the stator. The rotor is configured to rotate relative to the stator. The bearing is located between the rotor and the stator. The lip seal is located radially outward from the bearing. The lip seal includes a base and a flexible lip. The base is coupled to the rotor. The flexible lip extends from and is movable relative to the base. The flexible lip is configured to engage the seal plate when the rotor is not rotating relative to the stator. The flexible lip is further configured to be spaced apart from the seal plate when the rotor is rotating relative to the stator. In this regard, the flexible lip is configured to become spaced apart from the seal plate in response to a centrifugal rotational force transferred to the flexible lip when the rotor is rotating relative to the stator. The flexible lip is configured to move in an axially inward direction away from the seal plate in response to the centrifugal rotational force.

In some disclosed examples, the in-wheel electric motor further includes a bearing seal coupled to the bearing. The lip seal is located radially outward from the bearing seal. In some disclosed examples, the in-wheel electric motor further includes a gap located between the rotor and the seal plate. The flexible lip is configured to narrow or close the gap when the rotor is not rotating relative to the stator. The flexible lip is further configured to widen or open the gap when the rotor is rotating relative to the stator. In some disclosed examples, the in-wheel electric motor further includes a seal running surface coupled to the seal plate of the stator. The flexible lip is configured to engage the seal running surface when the rotor is not rotating relative to the stator. The flexible lip is further configured to be spaced apart from the seal running surface when the rotor is rotating relative to the stator. In some disclosed examples, the in-wheel electric motor further includes a labyrinth seal located radially outward from the lip seal. The labyrinth seal includes a plurality of first labyrinth elements formed by the stator and a plurality of second labyrinth elements formed by the rotor. Respective ones of the second labyrinth elements are interleaved with respective ones of the first labyrinth elements.

In some disclosed examples, an in-wheel electric motor includes a stator, a rotor, a bearing, and a lip seal. The stator includes a seal plate. The rotor circumscribes the stator. The rotor is configured to rotate relative to the stator. The bearing is located between the rotor and the stator. The lip seal is located radially outward from the bearing. The lip seal includes a base and a flexible lip. The base is coupled to the rotor. The flexible lip extends from and is movable relative to the base. The flexible lip is configured to engage the seal plate when the rotor is rotating relative to the stator at a rotational speed less than a threshold rotational speed. The flexible lip is further configured to be spaced apart from the seal plate of the stator when the rotor is rotating relative to the stator at a rotational speed greater than or equal to the threshold rotational speed. In this regard, the flexible lip is configured to become spaced apart from the seal plate in response to a centrifugal rotational force transferred to the flexible lip when the rotor is rotating relative to the stator at a rotational speed greater than or equal to the threshold rotational speed. The flexible lip is configured to move in an axially inward direction away from the seal plate in response to the centrifugal rotational force.

In some disclosed examples, the in-wheel electric motor further includes a bearing seal coupled to the bearing. The lip seal is located radially outward from the bearing seal. In some disclosed examples, the in-wheel electric motor further includes a gap located between the rotor and the seal plate. The flexible lip is configured to narrow or close the gap when the rotor is rotating relative to the stator at a rotational speed less than the threshold rotational speed. The flexible lip is further configured to widen or open the gap when the rotor is rotating relative to the stator at a rotational speed greater than or equal to the threshold rotational speed. In some disclosed examples, the in-wheel electric motor further includes a seal running surface coupled to the seal plate of the stator. The flexible lip is configured to engage the seal running surface when the rotor is rotating relative to the stator at a rotational speed less than the threshold rotational speed. The flexible lip is further configured to be spaced apart from the seal running surface when the rotor is rotating relative to the stator at a rotational speed greater than or equal to the threshold rotational speed. In some disclosed examples, the in-wheel electric motor further includes a labyrinth seal located radially outward from the lip seal. The labyrinth seal includes a plurality of first labyrinth elements formed by the stator and a plurality of second labyrinth elements formed by the rotor. Respective ones of the second labyrinth elements are interleaved with respective ones of the first labyrinth elements.

The above-identified features as well as other advantageous features of example seal assemblies for in-wheel outer rotor electric motors are further described below in connection with the figures of the application.

As used herein, the term “electric machine(s)” encompasses electric motor(s) configured to transform electrical energy into mechanical energy, and further encompasses electric generator(s) configured to transform mechanical energy into electrical energy.

As used herein, the term “bearing seal(s)” encompasses contact bearing seal(s) as well as non-contact bearing seal(s), and further encompasses bearing shield(s).

As used herein in a mechanical context, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part. As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the term “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

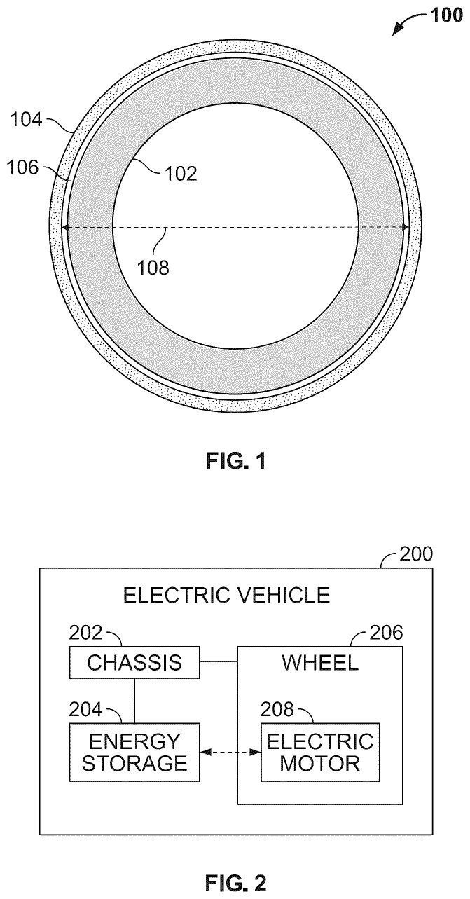

FIG. 1 is a side view of an example electric motor 100 having an outer rotor configuration. The electric motor 100 of FIG. 1 can be implemented in a manner that enables the electric motor 100 to function and/or operate either as an electric motor or as an electric generator. In the illustrated example of FIG. 1, the electric motor 100 includes an example stator 102 and an example rotor 104, with the stator 102 and the rotor 104 being arranged such that the rotor 104 circumscribes the stator 102. The rotor 104 of the electric motor 100 of FIG. 1 is configured to rotate relative to the stator 102. As shown in FIG. 1, the radial thickness of the stator 102 is substantially greater than the radial thickness of the rotor 104. The stator 102 and the rotor 104 are separated by an example air gap 106 having an example diameter 108 that generally corresponds to the inner diameter of the rotor 104. The presence of the air gap 106 facilitates rotation of the rotor 104 relative to the stator 102.

The diameter 108 of the air gap 106 of the electric motor 100 of FIG. 1 is substantially greater than a diameter of an air gap of a similarly-sized (e.g., identically sized) electric motor having an inner rotor configuration. The increased (e.g., maximized) diameter 108 of the air gap 106 associated with the outer rotor configuration of the electric motor 100 of FIG. 1 advantageously increases the volumetric torque density associated with the electric motor 100 relative to that of a similarly-sized electric motor having an inner rotor configuration. As a result, the outer rotor electric motor 100 of FIG. 1 is advantageously able to produce more torque in the package space (e.g., the overall volume of the motor) of the electric motor 100 in comparison to the torque which might be produced in the similarly-sized (e.g., identically-sized) package space (e.g., the overall volume of the motor) of an inner rotor electric motor. Outer rotor electric motors of the type shown in association with the electric motor 100 of FIG. 1 can accordingly be beneficial for applications requiring the generation of high levels of torque.

FIG. 2 is a block diagram of an example electric vehicle 200 including an in-wheel electric motor. While the electric vehicle 200 of FIG. 2 is illustrated as having a single in-wheel electric motor associated with a single electrically-driven wheel, it is to be understood that the electric vehicle 200 can alternatively include a different number (e.g., two, three, four, etc.) of in-wheel electric motors associated with a different number (e.g., two, three, four, etc.) of electrically-driven wheels. It is also to be understood that the electric vehicle 200 of FIG. 2 can include one or more wheel(s) that is/are not electrically driven in addition to the one or more electrically-driven wheel(s) that is/are associated with the in-wheel electric motor(s) of the electric vehicle 200. For example, when the electric vehicle 200 of FIG. 2 is implemented as a two-wheeled electric motorcycle, the electric vehicle 200 may include a rear wheel that incorporates an in-wheel electric motor, and a front wheel that does not incorporate an in-wheel electric motor. As another example, when the electric vehicle 200 of FIG. 2 is implemented as a four-wheeled electric automobile, the electric vehicle 200 may include two rear wheels, with each of the rear wheels incorporating an in-wheel electric motor, and two front wheels, with neither of the front wheels incorporating an in-wheel electric motor. Aside from requiring at least one in-wheel electric motor (i.e., one electric motor incorporated into one wheel), the electric vehicle 200 of FIG. 2 is not otherwise limited to any particular combination and/or configuration with regard to the number(s), type(s), and/or arrangement(s) of the electric motor(s), the wheel(s), and/or any other component(s) that may form part of the electric vehicle 200.

In the illustrated example of FIG. 2, the electric vehicle 200 includes an example chassis 202, an example energy storage 204, an example wheel 206, and an example electric motor 208. The chassis 202 of FIG. 2 is a structural framework configured to support and/or carry one or more other structural component(s) of the electric vehicle 200. For example, the chassis 202 can be implemented as a frame configured to carry and/or support the energy storage 204 and/or the wheel 206 of the electric vehicle 200. The specific size, shape, and/or configuration of the chassis 202 will vary depending upon the intended application. For example, the chassis 202 may have a first configuration when the electric vehicle 200 of FIG. 2 is implemented as a two-wheeled electric motorcycle, and a second, different configuration when the electric vehicle 200 is implemented as a four-wheeled electric automobile. The energy storage 204 of FIG. 2 is mechanically coupled to (e.g., supported and/or carried by) the chassis 202 of the electric vehicle 200 and operatively coupled to (e.g., in electrical communication with) the electric motor 208 of the electric vehicle 200. The energy storage 204 is configured to transfer energy to the electric motor 208, and/or to receive energy from the electric motor 208. For example, when the electric motor 208 is implemented in a manner that enables the electric motor 208 to function and/or operate either as an electric motor or as an electric generator, the energy storage 204 can either transfer electrical energy to the electric motor 208, which thereafter converts the electrical energy into mechanical energy, or the electric motor 208 can convert mechanical energy into electrical energy, and thereafter transfer the electrical energy to the energy storage 204. The energy storage 204 of FIG. 2 can be implemented as either a DC power source with an inverter to convert DC power to AC power, or as an AC power source.

The wheel 206 of FIG. 2 is mechanically coupled to (e.g., supported and/or carried by) the chassis 202 of the electric vehicle 200. The specific size, shape, and/or configuration of the wheel 206 will vary depending upon the intended application. For example, the wheel 206 may have a first configuration when the electric vehicle 200 of FIG. 2 is implemented as a two-wheeled electric motorcycle, and a second, different configuration when the electric vehicle 200 is implemented as a four-wheeled electric automobile. In the illustrated example of FIG. 2, the wheel 206 incorporates and/or otherwise includes the electric motor 208 such that the electric motor 208 constitutes an in-wheel electric motor. The electric motor 208 of FIG. 2 is mechanically coupled to (e.g., supported and/or carried by) the chassis 202 of the electric vehicle 200. The specific size, shape, and/or configuration of the electric motor 208 will vary depending upon the intended application. For example, the electric motor 208 may have a first configuration when the electric vehicle 200 of FIG. 2 is implemented as a two-wheeled electric motorcycle, and a second, different configuration when the electric vehicle 200 is implemented as a four-wheeled electric automobile. In the illustrated example of FIG. 2, the electric motor 208 is preferably implemented by and/or as an electric motor having an outer rotor configuration (e.g., the electric motor 100 of FIG. 1 described above) in which a rotor of the electric motor 208 circumscribes a stator of the electric motor 208, with the rotor being configured to rotate relative to the stator. In such an implementation, the wheel 206 includes a tire that circumscribes and is mechanically coupled to the rotor of the electric motor 208 such that rotation of the rotor causes a corresponding rotation of the tire.

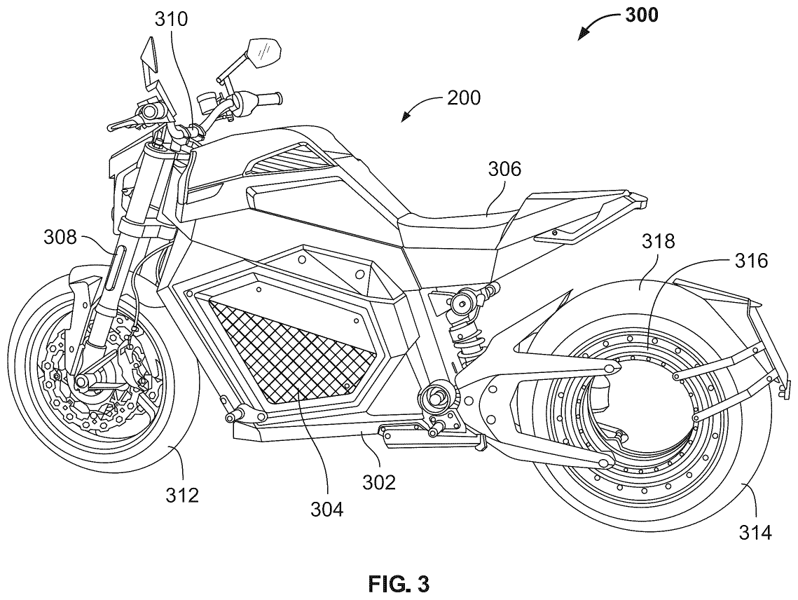

FIG. 3 is a perspective view of an example implementation of the electric vehicle 200 of FIG. 2. As shown in FIG. 3, the electric vehicle 200 is implemented as an electric motorcycle 300. An example chassis 302 of the electric motorcycle 300 (e.g., corresponding to the chassis 202 of FIG. 2) is configured to support and/or carry numerous structural component(s) of the electric motorcycle 300. For example, as shown in FIG. 3, the chassis 302 supports and/or carries an energy storage (e.g., a battery) that is concealed and/or otherwise located behind and/or within an example protective housing 304 associated with the chassis 302. The chassis 302 further supports and/or carries an example seat 306 of the electric motorcycle 300. The chassis 302 further supports and/or carries example forks 308 that support and/or carry example handlebars 310 and/or an example front wheel 312 of the electric motorcycle 300. The chassis 302 further supports and/or carries an example rear wheel 314 (e.g., corresponding to the wheel 206 of FIG. 2) that includes an example electric motor 316 (e.g., corresponding to the electric motor 208 of FIG. 2) of the electric motorcycle 300. The rear wheel 314 of the electric motorcycle 300 of FIG. 3 accordingly includes an in-wheel electric motor, while the front wheel 312 of the electric motorcycle 300 of FIG. 3 lacks any such in-wheel electric motor.

In the illustrated example of FIG. 3, the electric motor 316 is implemented in a manner that enables the electric motor 316 to function and/or operate either as an electric motor or as an electric generator. The electric motor 316 of the electric motorcycle 300 of FIG. 3 has an outer rotor configuration in which a rotor of the electric motor 316 circumscribes a stator of the electric motor 316, with the rotor being configured to rotate relative to the stator. The rear wheel 314 of the electric motorcycle 300 includes an example tire 318 that circumscribes and is mechanically coupled to the rotor of the electric motor 316 such that rotation of the rotor causes a corresponding rotation of the tire 318. The electric motorcycle 300 of FIG. 3 illustrates one of many possible example implementations of the electric vehicle 200 of FIG. 2. As discussed above, numerous other example implementations of the electric vehicle 200 of FIG. 2 are possible, are contemplated, and/or are within the scope of the inventions disclosed herein.

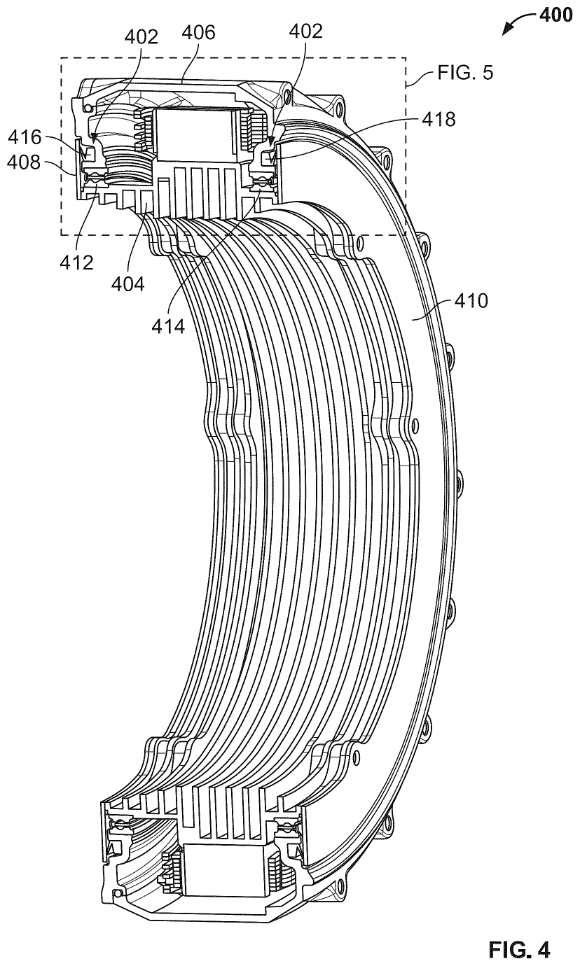

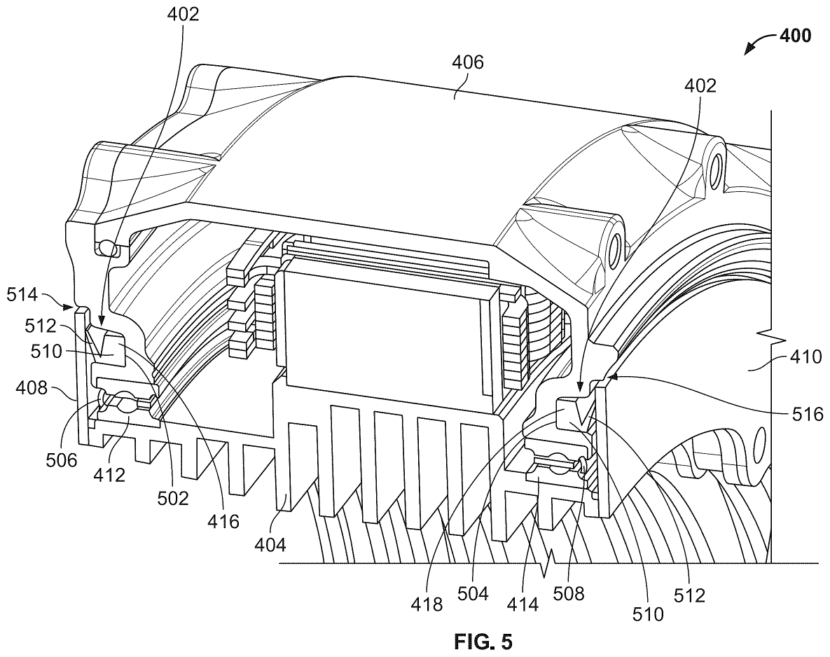

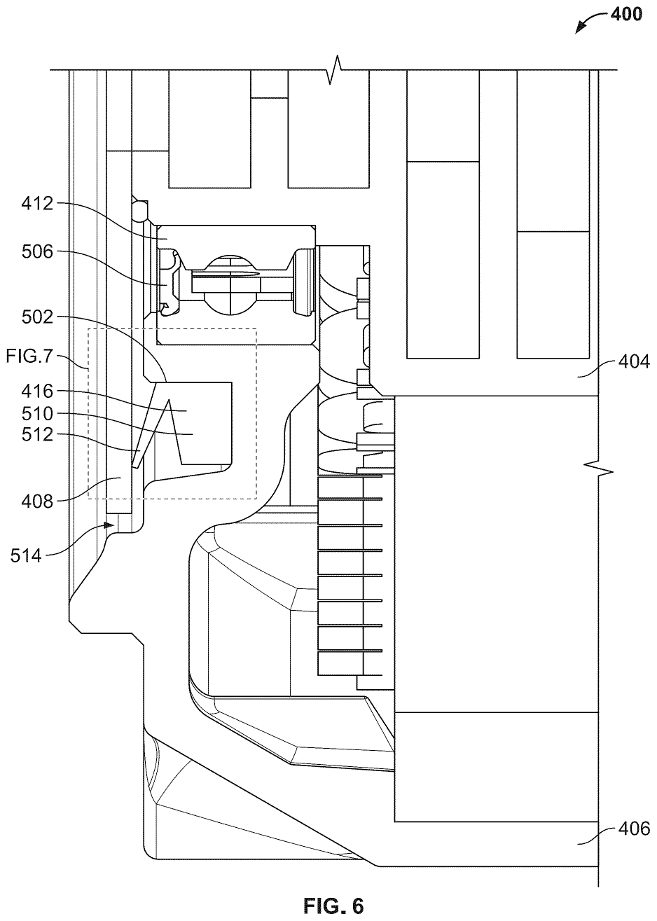

FIG. 4 is a perspective sectional view of an example electric motor 400 including a first example seal assembly 402. FIG. 5 is an enlarged view of a portion of FIG. 4. FIG. 6 is a cross-sectional view of a portion of the electric motor 400 of FIG. 4. In the illustrated example of FIGS. 4-6, the electric motor 400 includes an example stator 404 and an example rotor 406. The electric motor 400 of FIGS. 4-6 has an outer rotor configuration in which the rotor 406 of the electric motor 400 circumscribes the stator 404 of the electric motor 400, with the rotor 406 being configured to rotate relative to the stator 404. The stator 404 of the electric motor 400 of FIGS. 4-6 includes an example first seal plate 408 located along a first side (e.g., a left side) of the electric motor 400, and a second seal plate 410 located along a second side (e.g., a right side) of the electric motor 400 opposite the first side of the electric motor 400. In the illustrated example of FIGS. 4-6, each one of the first seal plate 408 and the second seal plate 410 of the stator 404 is removably coupled and/or otherwise removably attached (e.g., via one or more fastener(s)) to a central portion of the stator 404. The removable nature of the first seal plate 408 and the second seal plate 410 advantageously enables replacement of the first seal plate 408 and/or the second seal plate 410 when the first seal plate 408 and/or the second seal plate 410 become(s) worn. The first seal plate 408 and the second seal plate 410 are preferably formed from a hard material such as steel. The first seal plate 408 and the second seal plate 410 can alternatively be formed from a softer material (e.g., aluminum) that is coated with a hard material such as a ceramic or a hardening process such as hard anodizing.

In the illustrated example of FIGS. 4-6, the rotor 406 of the electric motor 400 includes an example first channel 502 formed in the rotor 406 along the first side of the electric motor 400, and an example second channel 504 formed in the rotor 406 along the second side of the electric motor 400. The electric motor 400 of FIGS. 4-6 further includes an example first bearing 412 located between the stator 404 and the rotor 406 at a position that is axially inward from the first seal plate 408 of the stator 404 and radially inward from the first channel 502 of the rotor 406, and an example second bearing 414 located between the stator 404 and the rotor 406 at a position that is axially inward from the second seal plate 410 of the stator 404 and radially inward from the second channel 504 of the rotor 406. In some examples, the first bearing 412 includes an example first bearing seal 506 coupled and/or otherwise attached thereto, and the second bearing 414 includes an example second bearing seal 508 coupled and/or otherwise attached thereto. The first bearing 412 and the second bearing 414 of the electric motor 400 of FIGS. 4-6 are respectively configured to facilitate (e.g., guide and/or support) rotation of the rotor 406 relative to the stator 404. The first bearing seal 506 and the second bearing seal 508 of the electric motor 400 of FIGS. 4-6 are respectively configured to retain grease and/or oil within corresponding ones of the first bearing 412 and the second bearing 414.

In the illustrated example of FIGS. 4-6, the first seal assembly 402 includes the first bearing seal 506 and the second bearing seal 508, and further includes an example first lip seal 416 located between the rotor 406 and the first seal plate 408 of the stator 404 at a position that is radially outward from the first bearing 412 and/or the first bearing seal 506, and an example second lip seal 418 located between the rotor 406 and the second seal plate 410 of the stator 404 at a position that is radially outward from the second bearing 414 and/or the second bearing seal 508. The first lip seal 416 of FIGS. 4-6 is located at least partially within the first channel 502 of the rotor 406. The second lip seal 418 of FIGS. 4-6 is located at least partially within the second channel 504 of the rotor 406.

In the illustrated example of FIGS. 4-6, each one of the lip seals (e.g., the first lip seal 416 and the second lip seal 418) of the first seal assembly 402 includes an example base 510 and an example flexible lip 512. The flexible lip 512 extends from and is movable relative to the base 510. In the illustrated example of FIGS. 4-6, the base 510 of the first lip seal 416 is coupled and/or otherwise attached (e.g., via a friction fit, via an adhesive, via one or more fastener(s), etc.) to the rotor 406 of the electric motor 400, with the base 510 of the first lip seal 416 being located at least partially within the first channel 502 of the rotor 406. The flexible lip 512 of the first lip seal 416 extends from the base 510 of the first lip seal 416 in a radially and axially outward direction relative to the point and/or the area at which the flexible lip 512 of the first lip seal 416 connects and/or otherwise attaches to the base 510 of the first lip seal 416. Similarly, the base 510 of the second lip seal 418 is coupled and/or otherwise attached (e.g., via a friction fit, via an adhesive, via one or more fastener(s), etc.) to the rotor 406 of the electric motor 400, with the base 510 of the second lip seal 418 being located at least partially within the second channel 504 of the rotor 406. The flexible lip 512 of the second lip seal 418 extends from the base 510 of the second lip seal 418 in a radially and axially outward direction relative to the point and/or the area at which the flexible lip 512 of the second lip seal 418 connects and/or otherwise attaches to the base 510 of the second lip seal 418.

Movement of the flexible lip 512 of each lip seal relative to the corresponding base 510 of each lip seal occurs in response to rotation of the rotor 406 of the electric motor 400 relative to the stator 404 of the electric motor 400. For example, the flexible lip 512 of the first lip seal 416 of FIGS. 4-6 is configured to engage (e.g., contact) the first seal plate 408 of the stator 404 when the rotor 406 of the electric motor 400 of FIGS. 4-6 is not rotating relative to the stator 404. The flexible lip 512 of the first lip seal 416 of FIGS. 4-6 is further configured to be spaced apart from (e.g., so as not to contact) the first seal plate 408 of the stator 404 when the rotor 406 of the electric motor 400 of FIGS. 4-6 is rotating relative to the stator 404. The flexible lip 512 of the first lip seal 416 of FIGS. 4-6 becomes spaced apart from the first seal plate 408 of the stator 404 in response to a centrifugal rotational force transferred to the flexible lip 512 of the first lip seal 416 when the rotor 406 is rotating relative to the stator 404. In this regard, the flexible lip 512 of the first lip seal 416 of FIGS. 4-6 is configured to move in an axially inward direction away from the first seal plate 408 of the stator 404 in response to the centrifugal rotational force that is generated by the rotation of the rotor 406.

Similarly, the flexible lip 512 of the second lip seal 418 of FIGS. 4-6 is configured to engage (e.g., contact) the second seal plate 410 of the stator 404 when the rotor 406 of the electric motor 400 of FIGS. 4-6 is not rotating relative to the stator 404. The flexible lip 512 of the second lip seal 4418 of FIGS. 4-6 is further configured to be spaced apart from (e.g., so as not to contact) the second seal plate 410 of the stator 404 when the rotor 406 of the electric motor 400 of FIGS. 4-6 is rotating relative to the stator 404. The flexible lip 512 of the second lip seal 418 of FIGS. 4-6 becomes spaced apart from the second seal plate 410 of the stator 404 in response to a centrifugal rotational force transferred to the flexible lip 512 of the second lip seal 418 when the rotor 406 is rotating relative to the stator 404. In this regard, the flexible lip 512 of the second lip seal 418 of FIGS. 4-6 is configured to move in an axially inward direction away from the second seal plate 410 of the stator 404 in response to the centrifugal rotational force that is generated by the rotation of the rotor.

In the illustrated example of FIGS. 4-6, an example first gap 514 (e.g., a first air gap) existing between the stator 404 and the rotor 406 along the first side of the electric motor 400 extends from a location that is external to the electric motor 400 to a location that is internal to the electric motor 400, with the first gap 514 extending to the first bearing seal 506 and/or the first bearing 412 of the electric motor 400. The first gap 514 accordingly passes between the first lip seal 416 and the first seal plate 408. The flexible lip 512 of the first lip seal 416 of FIGS. 4-6 is configured to narrow or close the first gap 514 at a location radially outward from the first bearing seal 506 and/or the first bearing 412 when the rotor 406 of the electric motor 400 of FIGS. 4-6 is not rotating relative to the stator 404. The flexible lip 512 of the first lip seal 416 of FIGS. 4-6 is further configured to widen or open the first gap 514 at a location radially outward from the first bearing seal 506 and/or the first bearing 412 when the rotor 406 of the electric motor 400 of FIGS. 4-6 is rotating relative to the stator 404.

An example second gap 516 (e.g., a second air gap) existing between the stator 404 and the rotor 406 along the second side of the electric motor 400 extends from a location that is external to the electric motor 400 to a location that is internal to the electric motor 400, with the second gap 516 extending to the second bearing seal 508 and/or the second bearing 414 of the electric motor 400. The second gap 516 accordingly passes between the second lip seal 418 and the second seal plate 410. The flexible lip 512 of the second lip seal 418 of FIGS. 4-6 is configured to narrow or close the second gap 516 at a location radially outward from the second bearing seal 508 and/or the second bearing 414 when the rotor 406 of the electric motor 400 of FIGS. 4-6 is not rotating relative to the stator 404. The flexible lip 512 of the second lip seal 418 of FIGS. 4-6 is further configured to widen or open the second gap 516 at a location radially outward from the second bearing seal 508 and/or the second bearing 414 when the rotor 406 of the electric motor 400 of FIGS. 4-6 is rotating relative to the stator 404.

In the examples described above, movement of the flexible lip 512 of each lip seal relative to the corresponding base 510 of each lip seal is triggered by the rotor 406 transitioning from a first operational state in which the rotor 406 is not rotating relative to the stator 404 into a second operational state in which the rotor 406 is rotating relative to the stator 404. In other examples, movement of the flexible lip 512 of each lip seal relative to the corresponding base 510 of each lip seal is instead triggered by the rotor 406 rotating relative to the stator 404 at a rotational speed that is greater than or equal to a threshold rotational speed. For example, the first lip seal 416 of the electric motor 400 of FIGS. 4-6 can be designed and/or configured such that the flexible lip 512 of the first lip seal 416 begins to move axially inward toward the base 510 of the first lip seal 416 (e.g., away from the first seal plate 408) when the rotor 406 of the electric motor 400 reaches or exceeds a threshold rotational speed of approximately one hundred revolutions per minute (100 rpm). In such examples, the centrifugal rotational force generated by the threshold rotational speed of the rotor 406 and acting on the flexible lip 512 of the first lip seal 416 exceeds the force of gravity acting on the flexible lip 512 of the first lip seal 416, thereby facilitating movement of the flexible lip 512 of the first lip seal 416 relative to the base 510 of the first lip seal 416. In other examples, the first lip seal 416 of the electric motor 400 of FIGS. 4-6 can instead be designed and/or configured such that the flexible lip 512 of the first lip seal 416 begins to move axially inward toward the base 510 of the first lip seal 416 (e.g., away from the first seal plate 408) when the rotor 406 of the electric motor 400 reaches or exceeds a threshold rotational speed that is substantially less than one hundred revolutions per minute (100 rpm). In still other examples, the first lip seal 416 of the electric motor 400 of FIGS. 4-6 can instead be designed and/or configured such that the flexible lip 512 of the first lip seal 416 begins to move axially inward toward the base 510 of the first lip seal 416 (e.g., away from the first seal plate 408) when the rotor 406 of the electric motor 400 reaches or exceeds a threshold rotational speed that is substantially greater than one hundred revolutions per minute (100 rpm).

In examples wherein movement of the flexible lip 512 of each lip seal relative to the corresponding base 510 of each lip seal is triggered by the rotor 406 rotating relative to the stator 404 at a rotational speed that is greater than or equal to a threshold rotational speed, the flexible lip 512 of the first lip seal 416 of FIGS. 4-6 is configured to engage (e.g., contact) the first seal plate 408 of the stator 404 when the rotor 406 of the electric motor 400 of FIGS. 4-6 is rotating relative to the stator 404 at a rotational speed that is less than the threshold rotational speed. The flexible lip 512 of the first lip seal 416 of FIGS. 4-6 is further configured to be spaced apart from (e.g., so as not to contact) the first seal plate 408 of the stator 404 when the rotor 406 of the electric motor 400 of FIGS. 4-6 is rotating relative to the stator 404 at a rotational speed that is greater than or equal to the threshold rotational speed. In such examples, the flexible lip 512 of the first lip seal 416 of FIGS. 4-6 becomes spaced apart from the first seal plate 408 of the stator 404 in response to a centrifugal rotational force transferred to the flexible lip 512 of the first lip seal 416 when the rotor 406 is rotating relative to the stator 404 at a rotational speed that is greater than or equal to the threshold rotational speed. In this regard, the flexible lip 512 of the first lip seal 416 of FIGS. 4-6 is configured to move in an axially inward direction away from the first seal plate 408 of the stator 404 in response to the centrifugal rotational force that is generated by the rotation of the rotor 406 when the rotational speed of the rotor 406 is greater than or equal to the threshold rotational speed.

Similarly in such examples, the flexible lip 512 of the second lip seal 418 of FIGS. 4-6 is configured to engage (e.g., contact) the second seal plate 410 of the stator 404 when the rotor 406 of the electric motor 400 of FIGS. 4-6 is rotating relative to the stator 404 at a rotational speed that is less than the threshold rotational speed. The flexible lip 512 of the second lip seal 418 of FIGS. 4-6 is further configured to be spaced apart from (e.g., so as not to contact) the second seal plate 410 of the stator 404 when the rotor 406 of the electric motor 400 of FIGS. 4-6 is rotating relative to the stator 404 at a rotational speed that is greater than or equal to the threshold rotational speed. In such other examples, the flexible lip 512 of the second lip seal 418 of FIGS. 4-6 becomes spaced apart from the second seal plate 410 of the stator 404 in response to a centrifugal rotational force transferred to the flexible lip 512 of the second lip seal 418 when the rotor 406 is rotating relative to the stator 404 at a rotational speed that is greater than or equal to the threshold rotational speed. In this regard, the flexible lip 512 of the second lip seal 418 of FIGS. 4-6 is configured to move in an axially inward direction away from the second seal plate 410 of the stator 404 in response to the centrifugal rotational force that is generated by the rotation of the rotor 406 when the rotational speed of the rotor 406 is greater than or equal to the threshold rotational speed.

In examples wherein movement of the flexible lip 512 of each lip seal relative to the corresponding base 510 of each lip seal is triggered by the rotor 406 rotating relative to the stator 404 at a rotational speed that is greater than or equal to a threshold rotational speed, the flexible lip 512 of the first lip seal 416 of FIGS. 4-6 is configured to narrow or close the first gap 514 at a location radially outward from the first bearing seal 506 and/or the first bearing 412 when the rotor 406 of the electric motor 400 of FIGS. 4-6 is rotating relative to the stator 404 at a rotational speed that is less than the threshold rotational speed. The flexible lip 512 of the first lip seal 416 of FIGS. 4-6 is further configured to widen or open the first gap 514 at a location radially outward from the first bearing seal 506 and/or the first bearing 412 when the rotor 406 of the electric motor 400 of FIGS. 4-6 is rotating relative to the stator 404 at a rotational speed that is greater than or equal to the threshold rotational speed. Similarly, the flexible lip 512 of the second lip seal 418 of FIGS. 4-6 is configured to narrow or close the second gap 516 at a location radially outward from the second bearing seal 508 and/or the second bearing 414 when the rotor 406 of the electric motor 400 of FIGS. 4-6 is rotating relative to the stator 404 at a rotational speed that is less than the threshold rotational speed. The flexible lip 512 of the second lip seal 418 of FIGS. 4-6 is further configured to widen or open the second gap 516 at a location radially outward from the second bearing seal 508 and/or the second bearing 414 when the rotor 406 of the electric motor 400 of FIGS. 4-6 is rotating relative to the stator 404 at a rotational speed greater than or equal to the threshold rotational speed.

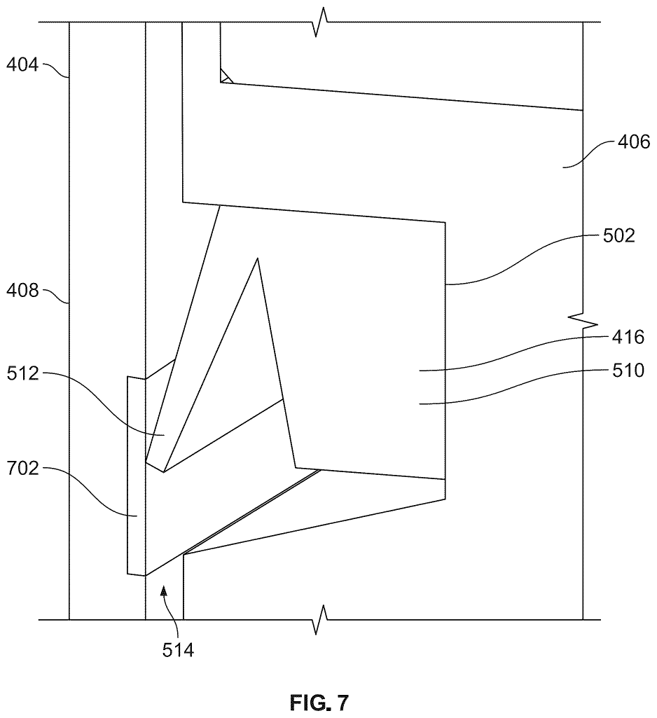

In some examples, each one of the seal plates (e.g., the first seal plate 408 and the second seal plate 410) of the stator 404 of FIGS. 4-6 can be modified to include a seal running surface that is configured to be selectively engaged (e.g., selectively contacted) by the corresponding one of the lip seals (e.g., the first lip seal 416 and the second lip seal 418) of the first seal assembly 402 of FIGS. 4-6. For example, FIG. 7 is an enlarged view of a portion of FIG. 6, with the first seal plate 408 of the stator 404 of FIGS. 4-6 modified to illustrate an example seal running surface 702. The seal running surface 702 of FIG. 7 is preferably formed from a hard material such as steel. The seal running surface 702 of FIG. 7 can alternatively be formed from a softer material (e.g., aluminum) that is coated with a hard material such as a ceramic or a hardening process such as hard anodizing.

In the illustrated example of FIG. 7, the first seal plate 408 of the stator 404 includes the seal running surface 702, with the seal running surface 702 being removably coupled and/or otherwise removably attached (e.g., via a friction fit, via an adhesive, via one or more fastener(s), etc.) to the first seal plate 408. The removable nature of the seal running surface 702 advantageously enables replacement of the seal running surface 702 when the seal running surface 702 becomes worn. The seal running surface 702 of FIG. 7 is configured to be selectively engaged (e.g., selectively contacted) by the first lip seal 416 of the electric motor 400 of FIGS. 4-6 described above. For example, as shown in FIG. 7, the flexible lip 512 of the first lip seal 416 is configured to engage (e.g., contact) the seal running surface 702 of the first seal plate 408 of the stator 404 when the rotor 406 of the electric motor 400 is not rotating relative to the stator 404. The flexible lip 512 of the first lip seal 416 is further configured to be spaced apart from (e.g., so as not to contact) the seal running surface 702 of the first seal plate 408 of the stator 404 when the rotor 406 of the electric motor 400 is rotating relative to the stator 404. The flexible lip 512 of the first lip seal 416 becomes spaced apart from the seal running surface 702 of the first seal plate 408 of the stator 404 in response to a centrifugal rotational force transferred to the flexible lip 512 of the first lip seal 416 when the rotor 406 is rotating relative to the stator 404. In this regard, the flexible lip 512 of the first lip seal 416 is configured to move in an axially inward direction away from the seal running surface 702 of the first seal plate 408 of the stator 404 in response to the centrifugal rotational force that is generated by the rotation of the rotor 406.

In examples wherein movement of the flexible lip 512 of the first lip seal 416 relative to the base 510 of the first lip seal 416 is triggered by the rotor 406 rotating relative to the stator 404 at a rotational speed that is greater than or equal to a threshold rotational speed, the flexible lip 512 of the first lip seal 416 is configured to engage (e.g., contact) the seal running surface 702 of the first seal plate 408 of the stator 404 when the rotor 406 of the electric motor 400 is rotating relative to the stator 404 at a rotational speed that is less than the threshold rotational speed. The flexible lip 512 of the first lip seal 416 is further configured to be spaced apart from (e.g., so as not to contact) the seal running surface 702 of the first seal plate 408 of the stator 404 when the rotor 406 of the electric motor 400 is rotating relative to the stator 404 at a rotational speed that is greater than or equal to the threshold rotational speed. In such examples, the flexible lip 512 of the first lip seal 416 becomes spaced apart from the seal running surface 702 of the first seal plate 408 of the stator 404 in response to a centrifugal rotational force transferred to the flexible lip 512 of the first lip seal 416 when the rotor 406 is rotating relative to the stator 404 at a rotational speed that is greater than or equal to the threshold rotational speed. In this regard, the flexible lip 512 of the first lip seal 416 is configured to move in an axially inward direction away from the seal running surface 702 of the first seal plate 408 of the stator 404 in response to the centrifugal rotational force that is generated by the rotation of the rotor 406 when the rotational speed of the rotor 406 is greater than or equal to the threshold rotational speed.

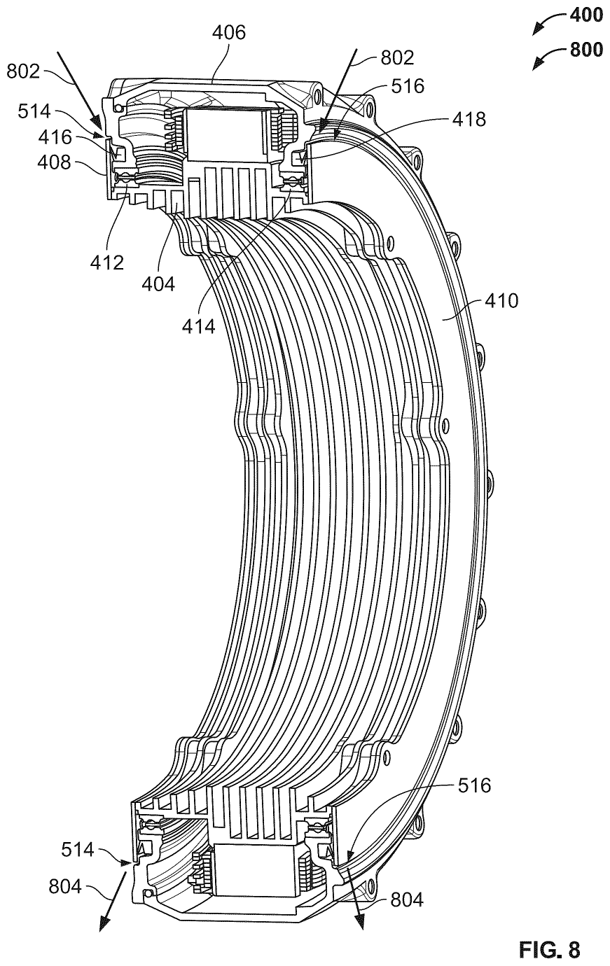

FIG. 8 is a perspective sectional view of the electric motor 400 of FIGS. 4-6 illustrating an example first operating state 800 of the electric motor 400. The first operating state 800 illustrated in FIG. 8 occurs when the rotor 406 of the electric motor 400 of FIGS. 4-6 is not rotating relative to the stator 404, and/or when the rotor 406 is rotating relative to the stator 404 at a rotational speed that is less than a threshold rotational speed. Under such conditions, the gravitational forces acting on the flexible lip 512 of the first lip seal 416 and the flexible lip 512 of the second lip seal 418 of FIGS. 4-6 exceed any centrifugal rotational forces that may be acting on the flexible lip 512 of the first lip seal 416 and/or the flexible lip 512 of the second lip seal 418. The flexible lip 512 of the first lip seal 416 accordingly remains engaged with (e.g., in contact with) the first seal plate 408, and the flexible lip 512 of the second lip seal 418 accordingly remains engaged with (e.g., in contact with) the second seal plate 410. While the first operating state 800 illustrated in FIG. 8 is occurring, contaminants and/or pollutants (e.g., liquid or solid matter not intended to be located within the electric motor 400) that may fall, under the force of gravity, into an upper portion (e.g., an upper half, or a top) of the first gap 514 associated with the first lip seal 416 and/or an upper portion (e.g., an upper half, or a top) of the second gap 516 associated with the second lip seal 418 (e.g., as generally indicated in FIG. 8 by arrows 802) are advantageously prevented, by the flexible lip 512 of the first lip seal 416 and/or the flexible lip 512 of the second lip seal 418, from reaching corresponding ones of the first bearing seal 506 and/or the first bearing 412, and/or the second bearing seal 508 and/or the second bearing 414 of the electric motor 400. Such contaminants and/or pollutants instead fall, under the force of gravity, out of a lower portion (e.g., a bottom half, or a bottom) of the first gap 514 associated with the first lip seal 416 and/or a lower portion (e.g., a bottom half, or a bottom) of the second gap 516 associated with the second lip seal 418 (e.g., as generally indicated in FIG. 8 by arrows 804).

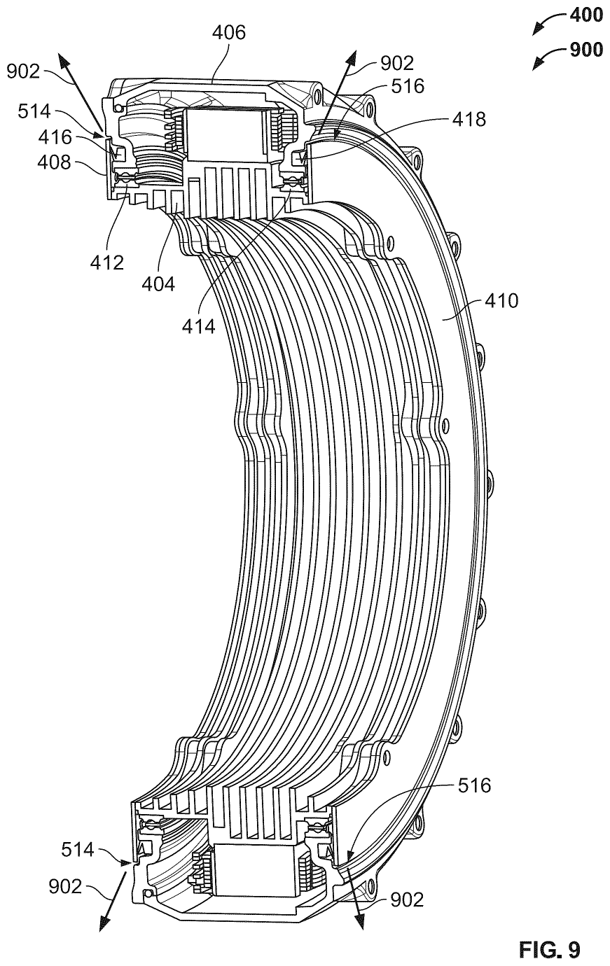

FIG. 9 is a perspective sectional view of the electric motor 400 of FIGS. 4-6 illustrating an example second operating state 900 of the electric motor 400. The second operating state 900 illustrated in FIG. 9 occurs when the rotor 406 of the electric motor 400 of FIGS. 4-6 is rotating relative to the stator 404 and, more specifically, when the rotor 406 is rotating relative to the stator 404 at a rotational speed that is greater than or equal to a threshold rotational speed. Under such conditions, the gravitational forces acting on the flexible lip 512 of the first lip seal 416 and the flexible lip 512 of the second lip seal 418 of FIGS. 4-6 are exceeded by the centrifugal rotational forces acting on the flexible lip 512 of the first lip seal 416 and/or the flexible lip 512 of the second lip seal 418. The flexible lip 512 of the first lip seal 416 accordingly becomes spaced apart from (e.g., not in contact with) the first seal plate 408, and the flexible lip 512 of the second lip seal 418 accordingly becomes spaced apart from (e.g., not in contact) the second seal plate 410. While the second operating state 900 illustrated in FIG. 9 is occurring, contaminants and/or pollutants (e.g., liquid or solid matter not intended to be located within the electric motor 400) that may be present within any portion of the first gap 514 leading up to the first bearing seal 506 and/or the first bearing 412, and/or within any portion of the second gap 516 leading up to the second bearing seal 508 and/or the second bearing 414, are propelled in a radially outward direction, via the acting centrifugal rotational forces, out of the first gap 514 and/or out of the second gap 516 of the electric motor 400 (e.g., as generally indicated in FIG. 9 by arrows 902). Furthermore, the lack of contact between the flexible lip 512 of the first lip seal 416 and the first seal plate 408 and/or the lack of contact between the flexible lip 512 of the second lip seal 418 and the second seal plate 410 while the second operating state 900 illustrated in FIG. 9 is occurring advantageously reduces friction (lowering losses), reduces heat generation, and reduces wear, as previously mentioned.

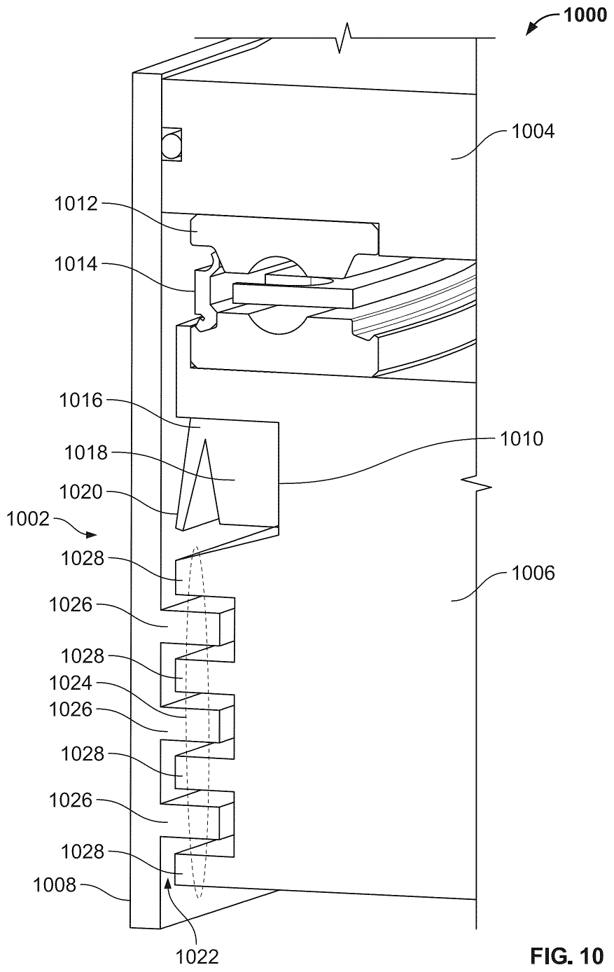

In some examples, each side of the electric motor 400 and/or each side of the first seal assembly 402 as shown in FIGS. 4-6 can be modified to further include a labyrinth seal located radially outward from the corresponding one of the lip seals (e.g., the first lip seal 416 and the second lip seal 418) of the first seal assembly 402, with each labyrinth seal being configured to provide a labyrinth (e.g., a tortuous and/or winding pathway) between the stator 404 and the rotor 406 at a location that is radially outward from the corresponding one of the lip seals. For example, FIG. 10 is a perspective sectional view of an example electric motor 1000 including a second example seal assembly 1002. In the illustrated example of FIG. 10, the electric motor 1000 includes an example stator 1004 and an example rotor 1006. The electric motor 1000 of FIG. 10 has an outer rotor configuration in which the rotor 1006 of the electric motor 1000 circumscribes the stator 1004 of the electric motor 1000, with the rotor 1006 being configured to rotate relative to the stator 1004. The stator 1004 of the electric motor 1000 of FIG. 10 includes an example seal plate 1008 located along a side (e.g., a left side) of the electric motor 1000. In the illustrated example of FIG. 10, the seal plate 1008 of the stator 1004 is removably coupled and/or otherwise removably attached (e.g., via one or more fastener(s)) to a central portion of the stator 1004. The removable nature of the seal plate 1008 advantageously enables replacement of the seal plate 1008 when the seal plate 1008 becomes worn. The seal plate 1008 is preferably formed from a hard material such as steel. The seal plate 1008 can alternatively be formed from a softer material (e.g., aluminum) that is coated with a hard material such as a ceramic or a hardening process such as hard anodizing.

In the illustrated example of FIG. 10, the rotor 1006 of the electric motor 1000 includes an example channel 1010 formed in the rotor 1006 along the side of the electric motor 1000. The electric motor 1000 of FIG. 10 further includes an example bearing 1012 located between the stator 1004 and the rotor 1006 at a position that is axially inward from the seal plate 1008 of the stator 1004 and radially inward from the channel 1010 of the rotor 1006. In the illustrated example of FIG. 10, the bearing 1012 includes an example bearing seal 1014 coupled and/or otherwise attached thereto. The bearing 1012 is configured to facilitate (e.g., guide and/or support) rotation of the rotor 1006 relative to the stator 1004. The bearing seal 1014 is configured to retain grease and/or oil within the bearing 1012.

In the illustrated example of FIG. 10, the second seal assembly 1002 includes the bearing seal 1014, and further includes an example lip seal 1016 located between the rotor 1006 and the seal plate 1008 of the stator 1004 at a position that is radially outward from the bearing 1012 and/or the bearing seal 1014. The lip seal 1016 of FIG. 10 is located at least partially within the channel 1010 of the rotor 1006. In the illustrated example of FIG. 10, the lip seal 1016 of the second seal assembly 1002 includes an example base 1018 and an example flexible lip 1020. The flexible lip 1020 extends from and is movable relative to the base 1018. In the illustrated example of FIG. 10, the base 1018 of the lip seal 1016 is coupled and/or otherwise attached (e.g., via a friction fit, via an adhesive, via one or more fastener(s), etc.) to the rotor 1006 of the electric motor 1000, with the base 1018 of the lip seal 1016 being located at least partially within the channel 1010 of the rotor 1006. The flexible lip 1020 of the lip seal 1016 extends from the base 1018 of the lip seal 1016 in a radially and axially outward direction relative to the point and/or the area at which the flexible lip 1020 of the lip seal 1016 connects and/or otherwise attaches to the base 1018 of the lip seal 1016.

Movement of the flexible lip 1020 of the lip seal 1016 relative to the base 1018 of the lip seal 1016 occurs in response to rotation of the rotor 1006 of the electric motor 1000 relative to the stator 1004 of the electric motor 1000. For example, the flexible lip 1020 of the lip seal 1016 of FIG. 10 is configured to engage (e.g., contact) the seal plate 1008 of the stator 1004 when the rotor 1006 of the electric motor 1000 of FIG. 10 is not rotating relative to the stator 1004. The flexible lip 1020 of the lip seal 1016 of FIG. 10 is further configured to be spaced apart from (e.g., so as not to contact) the seal plate 1008 of the stator 1004 when the rotor 1006 of the electric motor 1000 of FIG. 10 is rotating relative to the stator 1004. The flexible lip 1020 of the lip seal 1016 of FIG. 10 becomes spaced apart from the seal plate 1008 of the stator 1004 in response to a centrifugal rotational force transferred to the flexible lip 1020 of the lip seal 1016 when the rotor 1006 is rotating relative to the stator 1004. In this regard, the flexible lip 1020 of the lip seal 1016 of FIG. 10 is configured to move in an axially inward direction away from the seal plate 1008 of the stator 1004 in response to the centrifugal rotational force that is generated by the rotation of the rotor 1006.

In the illustrated example of FIG. 10, an example gap 1022 (e.g., an air gap) existing between the stator 1004 and the rotor 1006 along the side of the electric motor 1000 extends from a location that is external to the electric motor 1000 to a location that is internal to the electric motor 1000, with the gap 1022 extending to the bearing seal 1014 and/or the bearing 1012 of the electric motor 1000. The gap 1022 accordingly passes between the lip seal 1016 and the seal plate 1008. The flexible lip 1020 of the lip seal 1016 of FIG. 10 is configured to narrow or close the gap 1022 at a location radially outward from the bearing seal 1014 and/or the bearing 1012 when the rotor 1006 of the electric motor 1000 of FIG. 10 is not rotating relative to the stator 1004. The flexible lip 1020 of the lip seal 1016 of FIG. 10 is further configured to widen or open the gap 1022 at a location radially outward from the bearing seal 1014 and/or the bearing 1012 when the rotor 1006 of the electric motor 1000 of FIG. 10 is rotating relative to the stator 1004.

In the examples described above, movement of the flexible lip 1020 of the lip seal 1016 relative to the base 1018 of the lip seal 1016 is triggered by the rotor 1006 transitioning from a first operational state in which the rotor 1006 is not rotating relative to the stator 1004 into a second operational state in which the rotor 1006 is rotating relative to the stator 1004. In other examples, movement of the flexible lip 1020 of the lip seal 1016 relative to the base 1018 of the lip seal 1016 is instead triggered by the rotor 1006 rotating relative to the stator 1004 at a rotational speed that is greater than or equal to a threshold rotational speed. For example, the lip seal 1016 of the electric motor 1000 of FIG. 10 can be designed and/or configured such that the flexible lip 1020 of the lip seal 1016 begins to move axially inward toward the base 1018 of the lip seal 1016 (e.g., away from the seal plate 1008) when the rotor 1006 of the electric motor 1000 reaches or exceeds a threshold rotational speed of approximately one hundred revolutions per minute (100 rpm). In such examples, the centrifugal rotational force associated with the threshold rotational speed of the rotor 1006 and acting on the flexible lip 1020 of the lip seal 1016 exceeds the force of gravity acting on the flexible lip 1020 of the lip seal 1016, thereby facilitating movement of the flexible lip 1020 of the lip seal 1016 relative to the base 1018 of the lip seal 1016. In other examples, the lip seal 1016 of the electric motor 1000 of FIG. 10 can instead be designed and/or configured such that the flexible lip 1020 of the lip seal 1016 begins to move axially inward toward the base 1018 of the lip seal 1016 (e.g., away from the seal plate 1008) when the rotor 1006 of the electric motor 1000 reaches or exceeds a threshold rotational speed that is substantially less than one hundred revolutions per minute (100 rpm). In still other examples, the lip seal 1016 of the electric motor 1000 of FIG. 10 can instead be designed and/or configured such that the flexible lip 1020 of the lip seal 1016 begins to move axially inward toward the base 1018 of the lip seal 1016 (e.g., away from the seal plate 1008) when the rotor 1006 of the electric motor 1000 reaches or exceeds a threshold rotational speed that is substantially greater than one hundred revolutions per minute (100 rpm).

In examples wherein movement of the flexible lip 1020 of the lip seal 1016 relative to the base 1018 of the lip seal 1016 is triggered by the rotor 1006 rotating relative to the stator 1004 at a rotational speed that is greater than or equal to a threshold rotational speed, the flexible lip 1020 of the lip seal 1016 of FIG. 10 is configured to engage (e.g., contact) the seal plate 1008 of the stator 1004 when the rotor 1006 of the electric motor 1000 of FIG. 10 is rotating relative to the stator 1004 at a rotational speed that is less than the threshold rotational speed. The flexible lip 1020 of the lip seal 1016 of FIG. 10 is further configured to be spaced apart from (e.g., so as not to contact) the seal plate 1008 of the stator 1004 when the rotor 1006 of the electric motor 1000 of FIG. 10 is rotating relative to the stator 1004 at a rotational speed that is greater than or equal to the threshold rotational speed. In such examples, the flexible lip 1020 of the lip seal 1016 of FIG. 10 becomes spaced apart from the seal plate 1008 of the stator 1004 in response to a centrifugal rotational force transferred to the flexible lip 1020 of the lip seal 1016 when the rotor 1006 is rotating relative to the stator 1004 at a rotational speed that is greater than or equal to the threshold rotational speed. In this regard, the flexible lip 1020 of the lip seal 1016 of FIG. 10 is configured to move in an axially inward direction away from the seal plate 1008 of the stator 1004 in response to the centrifugal rotational force that is generated by the rotation of the rotor 1006 when the rotational speed of the rotor 1006 is greater than or equal to the threshold rotational speed.

In examples wherein movement of the flexible lip 1020 of the lip seal 1016 relative to the base 1018 of the lip seal 1016 is triggered by the rotor 1006 rotating relative to the stator 1004 at a rotational speed that is greater than or equal to a threshold rotational speed, the flexible lip 1020 of the lip seal 1016 of FIG. 10 is configured to narrow or close the gap 1022 at a location radially outward from the bearing seal 1014 and/or the bearing 1012 when the rotor 1006 of the electric motor 1000 of FIG. 10 is rotating relative to the stator 1004 at a rotational speed that is less than the threshold rotational speed. The flexible lip 1020 of the lip seal 1016 of FIG. 10 is further configured to widen or open the gap 1022 at a location radially outward from the bearing seal 1014 and/or the bearing 1012 when the rotor 1006 of the electric motor 1000 of FIG. 10 is rotating relative to the stator 1004 at a rotational speed that is greater than or equal to the threshold rotational speed.

In the illustrated example of FIG. 10, the second seal assembly 1002 further includes an example labyrinth seal 1024 located radially outward from the lip seal 1016 of the second seal assembly 1002. The labyrinth seal 1024 includes a plurality of example first labyrinth elements 1026 formed by the stator 1004 of the electric motor 1000, and a plurality of example second labyrinth elements 1028 formed by the rotor 1006 of the electric motor 1000. In the illustrated example of FIG. 10, respective ones of the second labyrinth elements 1028 are interleaved with respective ones of the first labyrinth elements 1026, thereby forming a labyrinth (e.g., a tortuous and/or winding pathway) that constitutes part of the gap 1022 existing between the stator 1004 and the rotor 1006. Locating the labyrinth seal 1024 radially outward from the lip seal 1016 advantageously exposes the labyrinth seal 1024 to a heightened (e.g., increased) application of the centrifugal rotational force that is generated via rotation of the rotor 1006 relative to the stator 1004.

In some examples, the electric motor 1000 and/or the second seal assembly 1002 as shown in FIG. 10 can be modified to omit the lip seal 1016. Such an arrangement is advantageous as there is no longer a surface speed limitation imposed by the lip seal 1016. In the absence of physical contact between the lip seal 1016 and the seal plate 1008, frictional losses, local temperatures, and/or general wear is/are reduced, even at low rotational speeds of the rotor 1006 of the electric motor 1000. These same benefits can be achieved by replacing the lip seal 1016 with a non-contact bearing seal, or with a bearing shield.

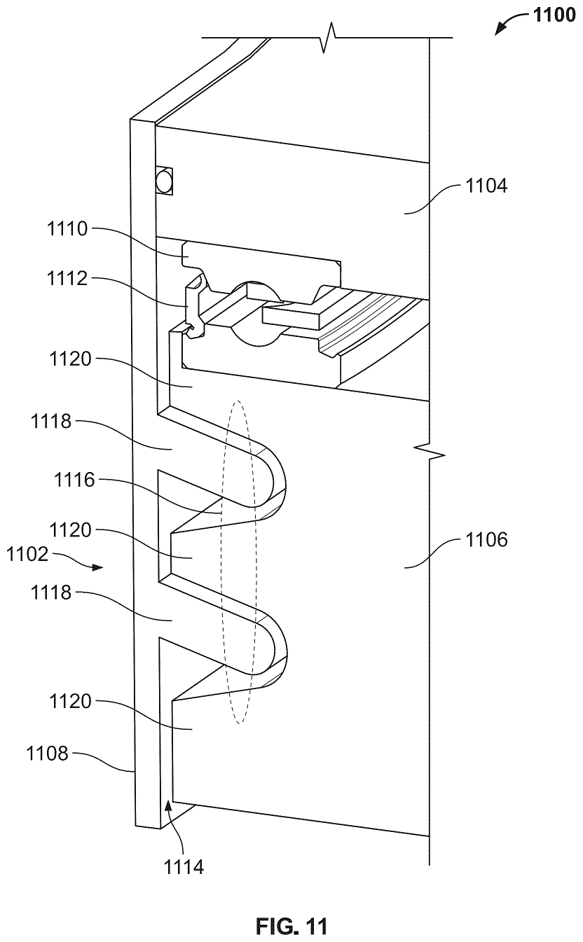

FIG. 11 is a perspective sectional view of an example electric motor 1100 including a third example seal assembly 1102. In the illustrated example of FIG. 11, the electric motor 1100 includes an example stator 1104 and an example rotor 1106. The electric motor 1100 of FIG. 11 has an outer rotor configuration in which the rotor 1106 of the electric motor 1100 circumscribes the stator 1104 of the electric motor 1100, with the rotor 1106 being configured to rotate relative to the stator 1104. The stator 1104 of the electric motor 1100 of FIG. 11 includes an example seal plate 1108 located along a side (e.g., a left side) of the electric motor 1100. In the illustrated example of FIG. 11, the seal plate 1108 of the stator 1104 is removably coupled and/or otherwise removably attached (e.g., via one or more fastener(s)) to a central portion of the stator 1104. The removable nature of the seal plate 1108 advantageously enables replacement of the seal plate 1108 when the seal plate 1108 becomes worn. In some examples, the seal plate 1108 is formed from a hard material such as steel. The seal plate 1108 can alternatively be formed from a softer material (e.g., aluminum) that is coated with a hard material such as a ceramic or a hardening process such as hard anodizing.

The electric motor 1100 of FIG. 11 further includes an example bearing 1110 located between the stator 1104 and the rotor 1106 at a position that is axially inward from the seal plate 1108. In the illustrated example of FIG. 11, the bearing 1110 includes an example bearing seal 1112 coupled and/or otherwise attached thereto. The bearing 1110 is configured to facilitate (e.g., guide and/or support) rotation of the rotor 1106 relative to the stator 1104. The bearing seal 1112 is configured to retain grease and/or oil within the bearing 1110. In the illustrated example of FIG. 11, an example gap 1114 (e.g., an air gap) existing between the stator 1104 and the rotor 1106 along the side of the electric motor 1100 extends from a location that is external to the electric motor 1100 to a location that is internal to the electric motor 1100, with the gap 1114 extending to the bearing seal 1112 and/or the bearing 1110 of the electric motor 1100.

In the illustrated example of FIG. 11, the third seal assembly 1102 includes an example labyrinth seal 1116 located radially outward from the bearing seal 1112 and/or the bearing 1110. The labyrinth seal 1116 includes a plurality of example first labyrinth elements 1118 formed by the stator 1104 of the electric motor 1100, and a plurality of example second labyrinth elements 1120 formed by the rotor 1106 of the electric motor 1100. In the illustrated example of FIG. 11, respective ones of the second labyrinth elements 1120 are interleaved with respective ones of the first labyrinth elements 1118, thereby forming a labyrinth (e.g., a tortuous and/or winding pathway) that constitutes part of the gap 1114 existing between the stator 1104 and the rotor 1106. Locating the labyrinth seal 1116 radially outward from the bearing seal 1112 advantageously exposes the labyrinth seal 1116 to a heightened (e.g., increased) application of the centrifugal rotational force that is generated via rotation of the rotor 1106 relative to the stator 1104.

The following paragraphs provide various examples in relation to the disclosed seal assemblies for in-wheel outer rotor electric motors.
Example 1 includes an in-wheel electric motor. In Example 1, the in-wheel electric motor includes a stator, a rotor, a bearing, and a lip seal. The stator includes a seal plate. The rotor circumscribes the stator. The rotor is configured to rotate relative to the stator. The bearing is located between the rotor and the stator. The lip seal is located radially outward from the bearing. The lip seal includes a base and a flexible lip. The base is coupled to the rotor. The flexible lip extends from and is movable relative to the base. The flexible lip is configured to engage the seal plate when the rotor is not rotating relative to the stator. The flexible lip is further configured to be spaced apart from the seal plate when the rotor is rotating relative to the stator.
Example 2 includes the in-wheel electric motor of Example 1. In Example 2, the flexible lip is configured to become spaced apart from the seal plate in response to a centrifugal rotational force transferred to the flexible lip when the rotor is rotating relative to the stator.
Example 3 includes the in-wheel electric motor of Example 2. In Example 3, the flexible lip is configured to move in an axially inward direction away from the seal plate in response to the centrifugal rotational force.
Example 4 includes the in-wheel electric motor of Example 1. In Example 4, the in-wheel electric motor further includes a gap located between the rotor and the seal plate. The flexible lip is configured to narrow or close the gap when the rotor is not rotating relative to the stator. The flexible lip is further configured to widen or open the gap when the rotor is rotating relative to the stator.
Example 5 includes the in-wheel electric motor of Example 1. In Example 5, the in-wheel electric motor further includes a bearing seal coupled to the bearing. The lip seal is located radially outward from the bearing seal.
Example 6 includes the in-wheel electric motor of Example 1. In Example 6, the seal plate includes a seal running surface. The flexible lip is configured to engage the seal running surface when the rotor is not rotating relative to the stator. The flexible lip is further configured to be spaced apart from the seal running surface when the rotor is rotating relative to the stator.
Example 7 includes the in-wheel electric motor of Example 1. In Example 7, the in-wheel electric motor further includes a labyrinth seal located radially outward from the lip seal. The labyrinth seal includes a plurality of first labyrinth elements formed by the stator and a plurality of second labyrinth elements formed by the rotor. Respective ones of the second labyrinth elements are interleaved with respective ones of the first labyrinth elements.
Example 8 includes an in-wheel electric motor. In Example 8, the in-wheel electric motor includes a stator, a rotor, a bearing, and a lip seal. The stator includes a seal plate. The rotor circumscribes the stator. The rotor is configured to rotate relative to the stator. The bearing is located between the rotor and the stator. The lip seal is located radially outward from the bearing. The lip seal includes a base and a flexible lip. The base is coupled to the rotor. The flexible lip extends from and is movable relative to the base. The flexible lip is configured to engage the seal plate when the rotor is rotating relative to the stator at a rotational speed less than a threshold rotational speed. The flexible lip is further configured to be spaced apart from the seal plate of the stator when the rotor is rotating relative to the stator at a rotational speed greater than or equal to the threshold rotational speed.
Example 9 includes the in-wheel electric motor of Example 8. In Example 9, the flexible lip is configured to become spaced apart from the seal plate in response to a centrifugal rotational force transferred to the flexible lip when the rotor is rotating relative to the stator at a rotational speed greater than or equal to the threshold rotational speed.
Example 10 includes the in-wheel electric motor of Example 9. In Example 10, the flexible lip is configured to move in an axially inward direction away from the seal plate in response to the centrifugal rotational force.
Example 11 includes the in-wheel electric motor of Example 8. In Example 11, the in-wheel electric motor further includes a gap located between the rotor and the seal plate. The flexible lip is configured to narrow or close the gap when the rotor is rotating relative to the stator at a rotational speed less than the threshold rotational speed. The flexible lip is further configured to widen or open the gap when the rotor is rotating relative to the stator at a rotational speed greater than or equal to the threshold rotational speed.
Example 12 includes the in-wheel electric motor of Example 8. In Example 12, the in-wheel electric motor further includes a bearing seal coupled to the bearing. The lip seal is located radially outward from the bearing seal.
Example 13 includes the in-wheel electric motor of Example 8. In Example 12, the seal plate includes a seal running surface. The flexible lip is configured to engage the seal running surface when the rotor is rotating relative to the stator at a rotational speed less than the threshold rotational speed. The flexible lip is further configured to be spaced apart from the seal running surface when the rotor is rotating relative to the stator at a rotational speed greater than or equal to the threshold rotational speed.
Example 14 includes the in-wheel electric motor of Example 8. In Example 14, the in-wheel electric motor further includes a labyrinth seal located radially outward from the lip seal. The labyrinth seal includes a plurality of first labyrinth elements formed by the stator and a plurality of second labyrinth elements formed by the rotor. Respective ones of the second labyrinth elements are interleaved with respective ones of the first labyrinth elements.
Example 15 includes an in-wheel electric motor. In Example 15, the in-wheel electric motor includes a stator, a rotor, a bearing, a bearing seal, and a lip seal. The stator includes a seal plate. The rotor circumscribes the stator. The rotor is configured to rotate relative to the stator. The bearing is located between the rotor and the stator. The bearing seal is coupled to the bearing. The lip seal is located radially outward from the bearing and the bearing seal. The lip seal includes a base and a flexible lip. The base is coupled to the rotor. The flexible lip extends from and is movable relative to the base. The flexible lip is configured to engage the seal plate when the rotor is rotating relative to the stator at a rotational speed less than a threshold rotational speed. The flexible lip is further configured to be spaced apart from the seal plate of the stator when the rotor is rotating relative to the stator at a rotational speed greater than or equal to the threshold rotational speed.
Example 16 includes the in-wheel electric motor of Example 15. In Example 16, the flexible lip is configured to become spaced apart from the seal plate in response to a centrifugal rotational force transferred to the flexible lip when the rotor is rotating relative to the stator at a rotational speed greater than or equal to the threshold rotational speed.
Example 17 includes the in-wheel electric motor of Example 16. In Example 17, the flexible lip is configured to move in an axially inward direction away from the seal plate in response to the centrifugal rotational force.
Example 18 includes the in-wheel electric motor of Example 15. In Example 18, the in-wheel electric motor further includes a gap located between the rotor and the seal plate. The flexible lip is configured to narrow or close the gap when the rotor is rotating relative to the stator at a rotational speed less than the threshold rotational speed. The flexible lip is further configured to widen or open the gap when the rotor is rotating relative to the stator at a rotational speed greater than or equal to the threshold rotational speed.
Example 19 includes the in-wheel electric motor of Example 15. In Example 19, the seal plate includes a seal running surface. The flexible lip is configured to engage the seal running surface when the rotor is rotating relative to the stator at a rotational speed less than the threshold rotational speed. The flexible lip is further configured to be spaced apart from the seal running surface when the rotor is rotating relative to the stator at a rotational speed greater than or equal to the threshold rotational speed.
Example 20 includes the in-wheel electric motor of Example 15. In Example 20, the in-wheel electric motor further includes a labyrinth seal located radially outward from the lip seal. The labyrinth seal includes a plurality of first labyrinth elements formed by the stator and a plurality of second labyrinth elements formed by the rotor. Respective ones of the second labyrinth elements are interleaved with respective ones of the first labyrinth elements.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An in-wheel electric motor, comprising:
a stator including a seal plate;
a rotor circumscribing the stator, the rotor configured to rotate relative to the stator;
a bearing located between the rotor and the stator; and
a lip seal located radially outward from the bearing, the lip seal including a base and a flexible lip, the base coupled to the rotor, the flexible lip extending from and movable relative to the base, the flexible lip configured to engage the seal plate when the rotor is not rotating relative to the stator, the flexible lip further configured to be spaced apart from the seal plate when the rotor is rotating relative to the stator.

2. The in-wheel electric motor of claim 1, wherein the flexible lip is configured to become spaced apart from the seal plate in response to a centrifugal rotational force transferred to the flexible lip when the rotor is rotating relative to the stator.

3. The in-wheel electric motor of claim 2, wherein the flexible lip is configured to move in an axially inward direction away from the seal plate in response to the centrifugal rotational force.

4. The in-wheel electric motor of claim 1, further comprising a gap located between the rotor and the seal plate, wherein the flexible lip is configured to narrow or close the gap when the rotor is not rotating relative to the stator, and wherein the flexible lip is further configured to widen or open the gap when the rotor is rotating relative to the stator.

5. The in-wheel electric motor of claim 1, further comprising a bearing seal coupled to the bearing, wherein the lip seal is located radially outward from the bearing seal.

6. The in-wheel electric motor of claim 1, wherein the seal plate includes a seal running surface, the flexible lip configured to engage the seal running surface when the rotor is not rotating relative to the stator, the flexible lip further configured to be spaced apart from the seal running surface when the rotor is rotating relative to the stator.

7. The in-wheel electric motor of claim 1, further comprising a labyrinth seal located radially outward from the lip seal, wherein the labyrinth seal includes a plurality of first labyrinth elements formed by the stator and a plurality of second labyrinth elements formed by the rotor, wherein respective ones of the second labyrinth elements are interleaved with respective ones of the first labyrinth elements.

8. An in-wheel electric motor, comprising:
a stator including a seal plate;
a rotor circumscribing the stator, the rotor configured to rotate relative to the stator;
a bearing located between the rotor and the stator; and
a lip seal located radially outward from the bearing, the lip seal including a base and a flexible lip, the base coupled to the rotor, the flexible lip extending from and movable relative to the base, the flexible lip configured to engage the seal plate when the rotor is rotating relative to the stator at a rotational speed less than a threshold rotational speed, the flexible lip further configured to be spaced apart from the seal plate of the stator when the rotor is rotating relative to the stator at a rotational speed greater than or equal to the threshold rotational speed.

9. The in-wheel electric motor of claim 8, wherein the flexible lip is configured to become spaced apart from the seal plate in response to a centrifugal rotational force transferred to the flexible lip when the rotor is rotating relative to the stator at a rotational speed greater than or equal to the threshold rotational speed.

10. The in-wheel electric motor of claim 9, wherein the flexible lip is configured to move in an axially inward direction away from the seal plate in response to the centrifugal rotational force.

11. The in-wheel electric motor of claim 8, further comprising a gap located between the rotor and the seal plate, wherein the flexible lip is configured to narrow or close the gap when the rotor is rotating relative to the stator at a rotational speed less than the threshold rotational speed, wherein the flexible lip is further configured to widen or open the gap when the rotor is rotating relative to the stator at a rotational speed greater than or equal to the threshold rotational speed.

12. The in-wheel electric motor of claim 8, further comprising a bearing seal coupled to the bearing, wherein the lip seal is located radially outward from the bearing seal.

13. The in-wheel electric motor of claim 8, wherein the seal plate includes a seal running surface, the flexible lip configured to engage the seal running surface when the rotor is rotating relative to the stator at a rotational speed less than the threshold rotational speed, the flexible lip further configured to be spaced apart from the seal running surface when the rotor is rotating relative to the stator at a rotational speed greater than or equal to the threshold rotational speed.

14. The in-wheel electric motor of claim 8, further comprising a labyrinth seal located radially outward from the lip seal, wherein the labyrinth seal includes a plurality of first labyrinth elements formed by the stator and a plurality of second labyrinth elements formed by the rotor, wherein respective ones of the second labyrinth elements are interleaved with respective ones of the first labyrinth elements.

15. An in-wheel electric motor, comprising:
a stator including a seal plate;
a rotor circumscribing the stator, the rotor configured to rotate relative to the stator;
a bearing located between the rotor and the stator;
a bearing seal coupled to the bearing; and
a lip seal located radially outward from the bearing and the bearing seal, the lip seal including a base and a flexible lip, the base coupled to the rotor, the flexible lip extending from and movable relative to the base, the flexible lip configured to engage the seal plate when the rotor is rotating relative to the stator at a rotational speed less than a threshold rotational speed, the flexible lip further configured to be spaced apart from the seal plate of the stator when the rotor is rotating relative to the stator at a rotational speed greater than or equal to the threshold rotational speed.

16. The in-wheel electric motor of claim 15, wherein the flexible lip is configured to become spaced apart from the seal plate in response to a centrifugal rotational force transferred to the flexible lip when the rotor is rotating relative to the stator at a rotational speed greater than or equal to the threshold rotational speed.

17. The in-wheel electric motor of claim 16, wherein the flexible lip is configured to move in an axially inward direction away from the seal plate in response to the centrifugal rotational force.

18. The in-wheel electric motor of claim 15, further comprising a gap located between the rotor and the seal plate, wherein the flexible lip is configured to narrow or close the gap when the rotor is rotating relative to the stator at a rotational speed less than the threshold rotational speed, wherein the flexible lip is further configured to widen or open the gap when the rotor is rotating relative to the stator at a rotational speed greater than or equal to the threshold rotational speed.

19. The in-wheel electric motor of claim 15, wherein the seal plate includes a seal running surface, the flexible lip configured to engage the seal running surface when the rotor is rotating relative to the stator at a rotational speed less than the threshold rotational speed, the flexible lip further configured to be spaced apart from the seal running surface when the rotor is rotating relative to the stator at a rotational speed greater than or equal to the threshold rotational speed.

20. The in-wheel electric motor of claim 15, further comprising a labyrinth seal located radially outward from the lip seal, wherein the labyrinth seal includes a plurality of first labyrinth elements formed by the stator and a plurality of second labyrinth elements formed by the rotor, wherein respective ones of the second labyrinth elements are interleaved with respective ones of the first labyrinth elements.
